(19) United States
(12) Patent Application Publication
(10) Pub. No.: US 2008/0075837 A1
(43) Pub. Date: Mar. 27, 2008

(54) Method of pattern coating

(76) Inventor: Christopher L. Bower, Ely (GB)

Correspondence Address: EASTMAN KODAK COMPANY;PATENT LEGAL STAFF, 343 STATE STREET, ROCHESTER, NY, 14650-2201, US

(21) Appl. No.: 11/666,250

(22) PCT Filed: Oct. 20, 2005
(86) PCT No.: PCT/GB05/04049

§ 371 Date: Nov. 6, 2007

(30) Foreign Application Priority Data
Oct. 29, 2004 (GB) 0424005.7

(51) Int. Cl. B05D 5/12; B05D 5/00; B05D 1/36; B05D 1/28

(52) U.S. Cl. 427/58; 427/256; 427/428.1; 427/402

(57) ABSTRACT

A method of coating well defined discrete areas of a flexible substrate in a continuous roll to roll manner with a coating composition comprising more than one distinct layer. The layers are coated simultaneously. The method comprises the steps of creating a lyophobic or lyophilic surface pattern on the substrate, a desired pattern of lyophilic or lyophobic areas being left, overcoating the created surface pattern with the layers of the coating composition, the layers of the composition withdrawing from the lyophobic areas and collecting on the lyophilic areas, the surface tension of the lowermost layer of the coating composition being greater than the surface tension in the layer above it.

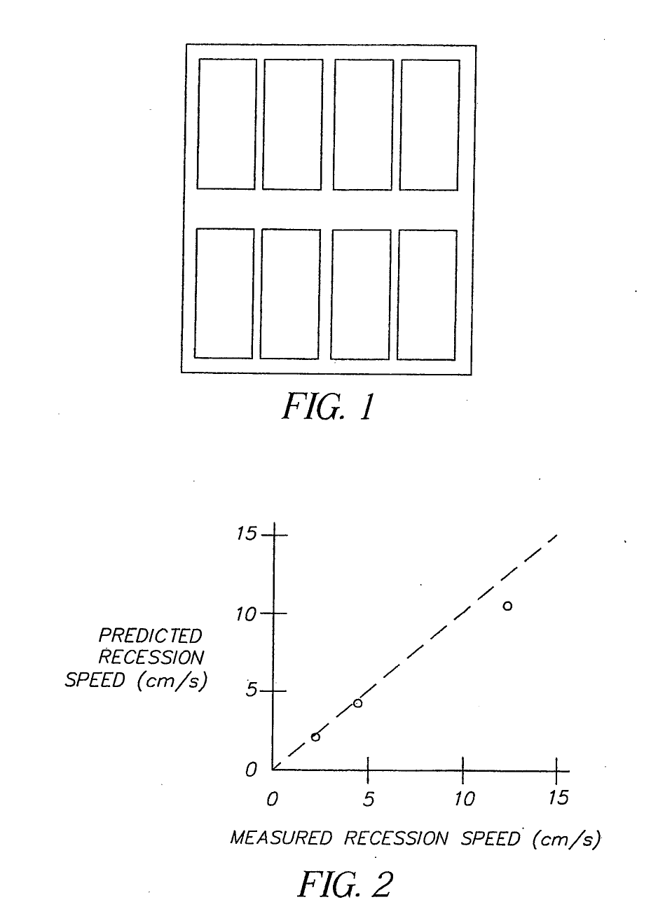

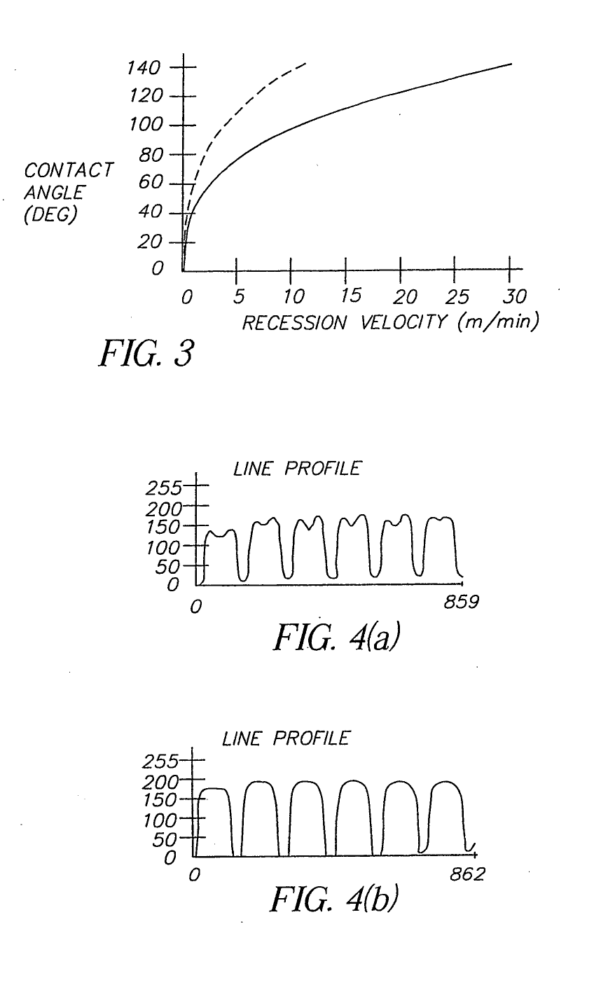

### FIELD OF THE INVENTION

The present invention relates to the field of coating, in particular to the simultaneous roll to roll coating of well defined discrete areas of a continuous web of material with multiple layers of liquid.

### BACKGROUND OF THE INVENTION

It is desirable to be able to coat discrete areas of a flexible support in a continuous roll-to-roll manner, to enable the fabrication of flexible electronics, micro lens arrays or display devices, etc. There are a variety of existing techniques based on printing technology, such as flexography, offset and screen printing, currently available to meet this desire, although generally the wet thickness of the coating generated by such techniques is limited to a few micrometers of material. To enable patterned coating of layers of greater thickness, additional printing steps must be used which then require accurate registration of the subsequent layers. The use of differential wettability to pattern the support prior to overcoating with the target liquid in a continuous manner—termed continuous discrete coating (CDC)—has been demonstrated in PCT/GB2004/002591. The CDC method allows the use of existing coating hardware to pattern much thicker layers.

PCT/GB2004/002591 discloses the CDC technique. U.S. Pat. No. 6,368,696 describes a method of depositing multiple layers and subsequently patterning the dried multilayer pack with an additional step, for the manufacture of plasma display panel. JP10337524A discloses a method of manufacture of a dielectric/electrode panel.

For simultaneous multilayer coating various coating hoppers can be used, as illustrated in U.S. Pat. No. 2,761,417, U.S. Pat. No. 2,761,418, U.S. Pat. No. 3,474,758, U.S. Pat. No. 2,761,419, U.S. Pat. No. 2,975,754, U.S. Pat. No. 3,005,440, U.S. Pat. No. 3,627,564, U.S. Pat. No. 3,749,053, U.S. Pat. No. 3,958,532, U.S. Pat. No. 3,993,019 and U.S. Pat. No. 3,996,885.

### PROBLEM TO BE SOLVED BY THE INVENTION

It is desirable to be able to create patterned, multiple-layer coatings for the fabrication of flexible electronics, micro lens arrays or display devices and such like products. When the patterned layers required are more than a few micrometers thick, then this requires multiple printing passes, in registration, to achieve the desired thickness. Screen printing offers the highest thickness layers but is limited in production speed and registration of subsequent layers is still problematic due to factors such as elongation or distortion of the screen.

Although there is prior art employing multilayer hopper coating to obtain thick functional layers, patterning is done as an additional step on the continuous dried layers. None of the prior art suggests patterning of the multiple wet layers at the coating point.

### SUMMARY OF THE INVENTION

In the method of the invention a pattern of differential wettability is first created on the flexible support by flexographic printing or other means. The support is then overcoated with multiple layers of the target composition simultaneously, in a single pass, using a multiple slot coating die such as is used in the manufacture of photographic products. The coating layers are optimised to minimise interlayer mixing and disturbance. The coating layers are then destabilised so as to recede from the lyophobic regions of the mask and remain only on the lyophilic regions by moving a minimal distance, with the layer structure remaining intact and in registry. The coating is then chill set and dried or cured.

According to the present invention there is provided a method of coating well defined discrete areas of a flexible substrate in a continuous roll to roll manner with a coating composition comprising more than one distinct layer, the layers being coated simultaneously, the method comprising the steps of creating a lyophobic or lyophilic surface pattern on the substrate, a desired pattern of lyophilic or lyophobic areas being left, overcoating the created surface pattern with the layers of coating composition, the layers of the composition withdrawing from the lyophobic areas and collecting on the lyophilic areas, wherein the surface tension of the lowermost layer of the coating composition is greater than the surface tension in the layer above it.

Preferably the lowermost layer of the composition has a greater thickness than the layer above. Preferably the lowermost layer of the composition also has a lower viscosity than the layer above.

### ADVANTAGEOUS EFFECT OF THE INVENTION

The present invention allows the simultaneous coating of several layers in registration, with well defined discrete areas. This leads to considerable improvements in productivity over multiple pass operations known in the prior art.

The invention enables the low cost manufacture of, for example, flexible displays, electronics, OLEDs, PLEDs, touch screens, fuel cells, solid state lighting, photovoltaic and other complex opto-electronic devices.

### DETAILED DESCRIPTION OF THE INVENTION

The method of the invention utilises the controlled deposition of a plurality of liquid layers to produce a pattern on a support. This is achieved by patterning the support web with a hydrophobic or an oleophobic (to allow patterning of aqueous liquids or of non-aqueous liquids respectively) material to form a mask. A hydrophilic or oleophilic surface pattern may alternatively be created.

The support web, or substrate, may be made of paper, plastic film, resin coated paper, synthetic paper or a conductive material. These are examples only.

The mask material may be deposited on the support using a flexographic printer roller. Alternative methods of creating the mask include; gravure coating, offset printing, screen printing, plasma deposition, photolithography, micro-contact printing, inkjet printing or selective removal of a uniform layer of the material by laser or other etching technique, optically writing with light or a laser, electrostatic spray or by plasma treatment. These are examples only and it will be understood by those skilled in the art that any suitable means may be used to create the mask pattern. The material used for the mask in the examples described below was a layer of fluoropolymer. However the invention is not limited to such a mask material. Other materials that might be used include aqueous based silicone release agents, or a chemical species containing one or more lyophobic moieties and one or more adhesive moieties. A superhydrophobic mask material that uses roughness in combination with hydrophobicity might also be used to improve the retraction of liquid into the hydrophilic regions of the mask.

Simultaneous multilayer overcoating of the masked support may be achieved by use of a multiple slot coating die typically used in the manufacture of multilayered photographic products, for example, in bead, curtain or x hopper coating configurations.

The mask re-arranges the coated liquid into the desired pattern by altering the wettability of the support. This process may be aided by using a device to create small holes or repellancy spots in the coating with the correct spatial and temporal frequency, so as to coincide with the lyophobic areas of the mask. In order to avoid undesirable mixing of the layers and achieve uniform coated regions, the layer stack has a specific range of viscosity and surface tension and thickness which varies with position within the stack.

The stack of coating layers is arranged so that the bottom layer that impinges upon the substrate has the highest surface tension. Preferably the bottom layer also has the lowest viscosity and the greatest thickness. Additional layers are formulated so as to have a lower surface tension and higher viscosity than underlying layers to ensure that they remain uniformly spread upon the lower layers. The topmost layer is formulated to have the lowest surface tension and highest viscosity of all the layers within the stack to prevent withdrawal from the underlying layers.

The liquid used as the coating composition may be a gelatin based material. However this is not essential to the invention. The coating composition may be chosen for specific properties that it may have. For instance, the coating composition may be chosen for its conductive properties or photonic properties. A further example would be the use of liquid crystal material as the coating composition. The coating composition may comprise a dispersion of carbon nano tubes. This provides a coating with excellent conductivity and transparency which may be used for the production of transparent conductors. It will be understood that the particular coating composition used will be chosen dependent on the use to which the coated web will be put. Examples include, but are not limited to, optoelectronic devices such as flexible displays and organic lasers, light guides, lens arrays or more complex integrated optics, patterned conductive layers, lighting panels and photovoltaic cells.

After the liquid composition has been deposited onto the substrate and has retracted from the masked areas the composition may be chill set and dried or cured.

Once the coated layers deposited in a first pass are dry additional layers can be deposited in registry with the original layers since the lyophobic mask will still direct these additional layers. In this manner thick patterned layers can be created without the usual problem of registration between successive layers encountered in other patterning techniques such as screen printing. In order to allow further uniform layers, or layers with a different pattern to that of the original mask to be coated onto the substrate it may be necessary to change to the lyophobic mask or surface pattern to lyophilic so that the next composition of layers coats uniformly. These uniform layers then act as a further substrate onto which a further mask pattern can be created and a further composition of layers coated. Subsequent patterned layers would be formed in the same way.

In the following examples gelatin based compositions were used. However the invention is not limited to such compositions.

### EXAMPLE 1

### 2 Layer Coatings

In the following examples 2 layers of aqueous gelatin solutions of varying viscosity, thickness and surface tension were coated onto a PET support using a slide hopper at a speed of 8 m/min. The support was masked with Fluoropel PFC604A to create a pattern of hydrophilic rectangles.

Coating Compositions used in following examples:

| | | % Surfactant | S.T. | Viscosity |
|---|---|---|---|---|
| Composition | % Gelatin | (10G) | (mNm⁻¹) | (@ 100s⁻¹ mPa · s) |
| A | 6 | 0.01 | 58.4 | 6 |
| B | 6 | 0 | 59.9 | 6 |
| C | 13 | 0.3 | 36.0 | 40 |
| D | 13 | 0.01 | 56.7 | 40 |
| E | 15 | 0.1 | 46.9 | 64 |

### EXAMPLE 1A

| | Roll 43 | Roll 44 | Roll 45 |
|---|---|---|---|
| Top layer | E @ 50 VS | E @ 30 VS | E @ 10 VS |
| Bottom layer | A @ 50 VS | A @ 70 VS | A @ 90 VS |

Total thickness 100 VS, viscous top layer with low surfactant concentration in top layer, low surfactant concentration in bottom layer.

### EXAMPLE 1B

| | Roll 46 | Roll 47 | Roll 48 |
|---|---|---|---|
| Top layer | E @ 50 VS | E @ 30 VS | E @ 10 VS |
| Bottom layer | B @ 50 VS | B @ 70 VS | B @ 90 VS |

Total thickness 100 VS, viscous top layer with low surfactant concentration in top layer, no surfactant concentration in bottom layer.

### EXAMPLE 1C

| | Roll 49 | Roll 50 | Roll 51 |
|---|---|---|---|
| Top layer | D @ 50 VS | D @ 30 VS | D @ 10 VS |
| Bottom layer | B @ 50 VS | B @ 70 VS | B @ 90 VS |

Total thickness 100 VS, no surfactant concentration in bottom layer, less viscous top layer with low surfactant concentration.

### EXAMPLE 1D

| | Roll 52 | Roll 53 | Roll 54 |
|---|---|---|---|
| Top layer | D @ 50 VS | D @ 30 VS | D @ 10 VS |
| Bottom layer | A @ 50 VS | A @ 70 VS | A @ 90 VS |

Total thickness 100 VS, low surfactant concentration in bottom layer, less viscous top layer with low surfactant concentration.

### EXAMPLE 1E

| | Roll 55 | Roll 56 | Roll 57 |
|---|---|---|---|
| Top layer | C @ 50 VS | C @ 30 VS | C @ 10 VS |
| Bottom layer | A @ 50 VS | A @ 70 VS | A @ 90 VS |

Total thickness 100 VS, less viscous top layer with high surfactant concentration, low surfactant concentration in bottom layer.

### EXAMPLE 1F

| | Roll 58 | Roll 59 | Roll 60 |
|---|---|---|---|
| Top layer | C @ 50 VS | C @ 30 VS | C @ 10 VS |
| Bottom layer | B @ 50 VS | B @ 70 VS | B @ 90 VS |

Total thickness 100 VS, less viscous top layer high surfactant concentration, no surfactant in bottom layer.

### EXAMPLE 1G

| | Roll 61 | Roll 62 | Roll 63 |
|---|---|---|---|
| Top layer | D @ 50 VS | D @ 30 VS | D @ 10 VS |
| Bottom layer | B @ 50 VS | B @ 70 VS | B @ 90 VS |

Total thickness 100 VS, less viscous top layer with low surfactant concentration, no surfactant in bottom layer.

TABLE 1
Results of Examples 1A to 1G
The table shows the degree to which the coated layer-stack has
retracted from the mask into the desired pattern, and also the
degree of retraction of the upper layers of the coating stack
from the layers below. It is desirable for complete retraction
from the mask coupled with minimal upper layer retraction.

| | | Retraction from | Upper layer |
|---|---|---|---|
| Example | Coating no. | Mask | retraction |
| 1A | 43 | Complete | Moderate |
| 1A | 44 | Incomplete | — |
| 1A | 45 | Incomplete | — |
| 1B | 46 | Incomplete | — |
| 1B | 47 | Incomplete | — |
| 1B | 48 | Incomplete | — |
| 1C | 49 | Incomplete | — |
| 1C | 50 | Incomplete | — |
| 1C | 51 | Complete | Moderate |
| 1D | 52 | Complete | Severe |
| 1D | 53 | Complete | Severe |
| 1D | 54 | Complete | Severe |
| 1E | 55 | Incomplete | — |
| 1E | 56 | Incomplete | — |
| 1E | 57 | Near-Complete | Moderate |
| 1F | 58 | Incomplete | — |
| 1F | 59 | Incomplete | — |
| 1F | 60 | Incomplete | — |
| 1G | 61 | Complete | Moderate |
| 1G | 62 | Complete | Moderate |
| 1G | 63 | Complete | Minimal |

### EXAMPLE 2

### 3 Layer Coatings

In the following examples 3 layers of aqueous gelatin compositions of varying viscosity, thickness and surface tension were coated onto a PET support using a slide hopper at a speed of 8 m/min. The support was masked with Fluoropel PFC604A to create a pattern of hydrophilic rectangles.

Coating compositions used in following examples:

| | | % | S.T. @ 40 | Viscosity |
|---|---|---|---|---|
| | | Surfactant | deg. C. | (@ 100s − 1 |
| Soln. | % Gelatin | (10G) | (mNm − 1) | mPa · s) |
| F | 4.5 | 0 | 60.8 | 4 |
| G | 6 | 0 | 60.4 | 6 |
| H | 13 | 0 | 58.2 | 40 |
| I | 13 | 0.001 | 57.8 | 40 |
| J | 13.5 | 0.01 | 56.8 | 45 |

### EXAMPLE 2A

| | Roll 11 | Roll 12 | Roll 13 |
|---|---|---|---|
| Top layer | J @ 10 VS | J @ 10 VS | J @ 15 VS |
| Middle layer | H @ 10 VS | H @ 20 VS | H @ 15 VS |
| Bottom layer | G @ 80 VS | G @ 70 VS | G @ 70 VS |

Total wet thickness 100 VS, no surfactant in bottom two layers, low surfactant concentration in top layer.

### EXAMPLE 2B

| | Roll 14 | Roll 15 | Roll 16 |
|---|---|---|---|
| Top layer | J @ 10 VS | J @ 10 VS | J @ 15 VS |
| Middle layer | I @ 10 VS | I @ 20 VS | I @ 15 VS |
| Bottom layer | G @ 80 VS | G @ 70 VS | G @ 70 VS |

Total wet thickness 100 VS, no surfactant in bottom layer, very low surfactant concentration in middle layer, low surfactant concentration in top layer.

### EXAMPLE 2C

| | Roll 17 | Roll 18 | Roll 19 |
|---|---|---|---|
| Top layer | J @ 10 VS | J @ 10 VS | J @ 15 VS |
| Middle layer | H @ 10 VS | H @ 20 VS | H @ 15 VS |
| Bottom layer | F @ 80 VS | F @ 70 VS | F @ 70 VS |

Total wet thickness 100 VS, low viscosity bottom layer with no surfactant, no surfactant in middle layer, low surfactant concentration in top layer.

### EXAMPLE 2D

| | Roll 20 | Roll 21 | Roll 22 |
|---|---|---|---|
| Top layer | J @ 10 VS | J @ 10 VS | J @ 15 VS |
| Middle layer | I @ 10 VS | I @ 20 VS | I @ 15 VS |
| Bottom layer | F @ 80 VS | F @ 70 VS | F @ 70 VS |

Total wet thickness 100 VS, low viscosity bottom layer with no surfactant, very low surfactant concentration in middle layer, low surfactant concentration in top layer

### EXAMPLE 2E

| | Roll 23 | Roll 24 | Roll 25 |
|---|---|---|---|
| Top layer | J @ 10 VS | J @ 20 VS | J @ 25 VS |
| Middle layer | H @ 40 VS | H @ 30 VS | H @ 25 VS |
| Bottom layer | F @ 50 VS | F @ 50 VS | F @ 50 VS |

Total wet thickness 100 VS, thinner, low viscosity bottom layer with no surfactant, no surfactant in middle layer, low surfactant concentration in top layer.

### EXAMPLE 2F

| | Roll 26 | Roll 27 | Roll 28 |
|---|---|---|---|
| Top layer | J @ 10 VS | J @ 20 VS | J @ 25 VS |
| Middle layer | I @ 40 VS | I @ 30 VS | I @ 25 VS |
| Bottom layer | F @ 50 VS | F @ 50 VS | F @ 50 VS |

Total wet thickness 100 VS, thinner, low viscosity bottom layer with no surfactant, very low surfactant concentration in middle layer, low surfactant concentration in top layer.

### EXAMPLE 2G

| | Roll 29 |
|---|---|
| Top layer | J @ 10 VS |
| Middle layer | I @ 10 VS |
| Bottom layer | F @ 100 VS |

Total wet thickness 120 VS, thicker, low viscosity bottom layer with no surfactant, very low surfactant concentration in middle layer, low surfactant concentration in top layer.

TABLE 2
Results from examples 2A to 2G.

| | | Retraction from | Upper layer |
|---|---|---|---|
| Example | Coating no. | Mask | retraction |
| 2A | 11 | Near-Complete | Moderate |
| 2A | 12 | Complete | Moderate |
| 2A | 13 | Near-Complete | Moderate |
| 2B | 14 | Complete | Moderate |
| 2B | 15 | Near-Complete | Moderate |
| 2B | 16 | Complete | Moderate |
| 2C | 17 | Complete | Minimal |
| 2C | 18 | Complete | Minimal |
| 2C | 19 | Complete | Minimal |
| 2D | 20 | Complete | Minimal |
| 2D | 21 | Near-Complete | Moderate |
| 2D | 22 | Complete | Minimal |
| 2E | 23 | Near-Complete | Moderate |
| 2E | 24 | Near-Complete | Minimal |
| 2E | 25 | Incomplete | Minimal |
| 2F | 26 | Incomplete | Minimal |
| 2F | 27 | Incomplete | Minimal |
| 2F | 28 | Incomplete | Minimal |
| 2G | 29 | Incomplete | Minimal |

As can be seen the best results are obtained when:
1) The bottom layer is relatively thick in comparison to the layer/s above it.
   Ideally, in a coating pack consisting of n layers with layer 1 at the bottom and layer n at the top, the pack should be arranged so that:
   Thickness of layer 1>thickness of layer 2 . . . >thickness of layer n
   The total thickness of the coating pack should not be so large as to prevent complete retraction of the pack into the desired pattern. In the experiments in the examples cited above the total thickness was in the region of 100 micrometers wet thickness. However it will be understood by those skilled in the art that the allowable thickness will be dependent upon the pattern, liquid composition, viscosity, surface tension and the mask material, amongst other factors.
2) The viscosity of the lowermost layer is as low as possible and lower than the layers above it.
   Viscosity of layer 1<viscosity of layer 2 . . . <viscosity of layer n
   With respect to the compositions in the examples described above the viscosity of the lowermost layer is in the range of 0-10 mPa.s. Preferably the viscosity would be in the range 3-6 mPa.s. The viscosity of the upper layer(s) is in the range of 12-60 mPa.s. Preferably the viscosity would be in the range of 20-40 mPa.s.
3) The upper layers are relatively thin and viscous in comparison to the bottom layer to ensure that they remain uniformly spread with minimal edge retraction upon the underlying layer.
   The fundamental physics of moving liquid contact lines involves a rolling motion of the liquid causing it to circulate as the wetting line moves, making some degree of retraction of the upper layers inevitable. However, when the above criteria are met, this effect can be reduced to an acceptable level, detectable in the final dried coating since it creates a unique stepped profile.
4) There is little or no surfactant in the bottom layer to allow complete retraction from the hydrophobic areas of the mask.
5) There is a minimal amount of surfactant in the layer(s) above required to keep the upper layers uniformly spread upon the underlying layers without allowing too much surfactant to diffuse through into the lowermost layer and prevent complete retraction from the mask.
   Surface tension of layer 1>surface tension of layer 2 . . . >surface tension of layer n
   The surface tension of the upper layer(s) should be low enough to ensure they remain spread uniformly upon the layer beneath. With respect to the compositions in the examples described above the surface tension of the lowermost layer could be in the range of 35-72 mNm⁻¹. Preferably the surface tension of the lowermost layer would be in the region of 40-35 mNm⁻¹. However the person skilled in the art will understand that these values are dependent on the combination of the pattern, the liquid composition, viscosity, mask material, etc.

The method has particular application to coating electronic displays. However the method is not limited to such applications. Continuous discrete patterned coating as described above, alone or in combination with other techniques, is useful in a wide range of high value products. Examples include optoelectronic devices such as flexible displays and organic lasers, light guides, lens arrays or more complex integrated optics, patterned conductive layers, lighting panels and photovoltaic cells.

The invention has been described in detail with reference to preferred embodiments thereof. It will be understood by those skilled in the art that variations and modifications can be effected within the scope of the invention.

1. A method of coating well defined discrete areas of a flexible substrate in a continuous roll to roll manner with a coating composition comprising more than one distinct layer, the layers being coated simultaneously, the method comprising the steps of creating a lyophobic or lyophilic surface pattern on the substrate, a desired pattern of lyophilic or lyophobic areas being left, overcoating the created surface pattern with the layers of coating composition, the layers of the composition withdrawing from the lyophobic areas and collecting on the lyophilic areas, wherein the surface tension of the lowermost layer of the coating composition is greater than the surface tension in the layer above it.

2. A method as claimed in claim 1 wherein the surface tension of the lowermost layer of the composition is in the region of 35-72 mNm⁻¹.

3. A method as claimed in claim 2 wherein the surface tension of the lowermost layer is in the region of 40-58 mNm⁻¹.

4. A method as claimed in claim 1 wherein the lowermost layer of the composition has a greater thickness than the layer above.

5. A method as claimed in claim 1 wherein the lowermost layer of the composition has a lower viscosity than the layer above.

6. A method as claimed in claim 5 wherein the viscosity of the lowermost layer is in the region of 0-10 mPa.s.

7. A method as claimed in claim 6 wherein the viscosity of the lowermost layer is in the region of 3-6 mPa.s.

8. A method as claimed in claim 5 wherein the viscosity of the layer(s) above the lowermost layer are in the region of 12-60 mPa.s.

9. A method as claimed in claim 8 wherein the viscosity of the layer(s) above the lowermost layer are in the region of 20-40 mPa.s.

10. A method as claimed in claim 1 wherein, in a coating pack of n layers, the nth layer being the furthest from the substrate, the surface tension of layer 1>surface tension of layer 2> . . . surface tension of layer n.

11. A method as claimed in claim 1 wherein, in a coating pack of n layers, the nth layer being the furthest from the substrate, the viscosity of layer 1<the viscosity of layer 2 . . . <the viscosity of layer n.

12. A method as claimed in claim 1 wherein, in a coating pack of n layers, the nth layer being the furthest from the substrate, the thickness of layer 1>the thickness of layer 2> . . . the thickness of layer n.

13. A method as claimed in claim 1 wherein the coating composition is a gelatin based material.

14. A method as claimed in claim 1 wherein the coating composition is a polymeric material.

15. A method as claimed in claim 1 wherein the coating composition comprises a dispersion of carbon nanotubes.

16. A method as claimed in claim 1 wherein the coating composition includes liquid crystal material.

17. A method as claimed in claim 1 wherein the coating composition includes surfactant.

18. A method as claimed in claim 1 wherein the coating composition is a dispersion.

19. A method as claimed in claim 1 wherein the surface pattern is created on the substrate by means of one of: flexographic printing, offset printing, gravure printing, screen printing, lithography, inkjet (continuous or drop on demand), micro contact printing, plasma deposition, plasma treatment, electrostatic spray or optical means using light or a laser to write the pattern or elective removal of a uniform layer of material by laser or other etching technique.

20. A method as claimed in claim 1 wherein the steps of creating a surface pattern on the substrate and overcoating the surface pattern with more than one layer of coating composition takes place inline.

21. A method as claimed in claim 1 wherein the layers of coating compositions are deposited onto the created surface pattern by means of pre-metered coating process.

22. A method as claimed in claim 1 wherein the coating composition is subsequently dried and cured.

23. A method as claimed in claim 1 wherein the coating composition, when dried and cured, has conductive and/or photonic properties.

24. A method as claimed in claim 1 wherein a coating composition of multiple layers is coated and dried and subsequently overcoated with another coating composition of multiple layers.

25. A method as claimed in claim 1 wherein the substrate is made of a material selected from a group consisting of paper, plastic films, resin coated paper, synthetic paper or conductive material.

26. A display device or component thereof formed by the method of claim 1.

27. A flexible display device or component thereof formed by the method of claim 1.

28. A transparent conductor formed at least in part by the method of claim 1.

29. A patterned layer on a support formed by the method of claim 1.
